(19) United States
(12) Patent Application Publication
(10) Pub. No.: US 2022/0044883 A1
(43) Pub. Date: Feb. 10, 2022

(54) Electrical normally open contact

(71) Applicant: Auto-Kabel Management GmbH, Hausen i.W. (DE)

(72) Inventor: Fabian Stellberg, Jülich (DE)

(21) Appl. No.: 17/422,388

(22) PCT Filed: Dec. 20, 2019
(86) PCT No.: PCT/EP2019/086581

§ 371 Date: Jul. 12, 2021

(30) Foreign Application Priority Data
Jan. 18, 2019 (DE) 10 2019 101 307.0

(51) Int. Cl. H01H 1/12; H01H 1/02; H01H 1/06

(52) U.S. Cl. CPC H01H 1/12; H01H 39/004; H01H 1/06; H01H 1/02

(57) ABSTRACT

An electric closer, in particular for a motor vehicle line, in particular a motor vehicle power line, comprising a first electrical terminal and a second electrical terminal, a first contact element which is electrically connected to the first terminal, a second contact element which is electrically connected to the second terminal, a connecting element with which an electrical connection can be established between the two contact elements, and a drive which effects a relative movement between the contact elements and connecting element, characterised in that the connecting element or the contact elements are formed at least in parts from an electrically conductive, porous metal.

The subject-matter concerns an electrical normally open contact (NO contact, electrical closer or make contact), in particular for a motor vehicle line, in particular a motor vehicle power line, for example a battery line, for example a battery-motor, battery starter, battery generator or starter-generator line.

In automotive applications, but also in other applications, the safety requirements are becoming increasingly stringent. Especially at high currents, a safe shutdown in case of a fault is necessary for safety reasons. Users, occupants and helpers must be safely protected against electric shocks.

In high-voltage applications with voltages of sometimes more than 1000V and simultaneously high currents, such as those found in automotive drive trains, reliable switching is necessary to ensure safe personal protection in the event of a fault or crash. One possible safety concept provides for a short-circuit of the live parts by means of an electrical normally open (NO) contact (make contact). The short-circuit caused by the NO contact disconnects the on-board power supply behind the short-circuit. At the same time, a short circuit has the advantage that switching under load is not necessary, where there is always the danger of an arc and thus a further flowing current. In addition, a NO contact can be designed in such a way that switching back is impossible, so that a permanent protection is guaranteed.

The subject matter was based on the object of providing an electrical normally open contact for safety-relevant systems, which closes reliably and where a switch-back is made difficult.

This object is solved by an electrical normally open contact according to claim 1.

For the connection of the electrical NO contact to a circuit, for example to a motor vehicle line or a motor vehicle power line, it has at least a first and a second electrical terminal. The respective electrical terminal can be formed as connecting lug, connecting bolt, screw terminal, crimp terminal, round cable or flat cable. The electrical NO contact can be enclosed in a separate housing and the terminals can be led out of the housing.

In addition, the electrical NO contact has a first contact element which is electrically connected to the first terminal and a second contact element which is electrically connected to the second terminal. The electrical contact elements are insulated from each other in the open position and spatially separated. The contact elements are preferably arranged inside the housing of the electrical closers.

A connecting element is provided for contacting the two contact elements with each other. The connecting element is made of an electrically conductive material and can be brought into contact with the two contact elements at the same time. This creates a short circuit through the contact elements and thus a closed position of the electrical NO contact is realized.

In order to bring the connecting element into contact with the contact elements, a relative movement, in particular a translatory movement, of at least one of the contact elements is effected in relation to the connecting element. In the open position, the connecting element is spatially separated from at least one of the contact elements and there is no electrical connection whatsoever both between the two contact elements and between at least one of the contact elements and the connecting element. In the open position, preferably none of the contact elements is connected to the connecting element. However, it is also possible that in the open position one of the contact elements is connected to the connecting element and the second contact element is electrically isolated from it. In this case a relative movement between the contact elements and the connecting element is such that the second contact element moves relative to the connecting element. However, it is also possible that the connecting element moves relative to at least one of the contact elements.

If the connecting element and one or both contact elements are moved relative to each other, mechanical and electrical contact between the contact elements and the connecting element occurs and the connecting element forms a short circuit between the two contact elements.

An electrically conductive material that encloses the connecting element offers good protection against resetting while at the same time being lightweight. Such a material can be a porous material. This can be in the form of a powder or a porous foam. The material can also be pasty or liquid. The material is preferably metallic. The material is electrically conductive.

It is proposed that the connecting element and/or the contact elements are formed at least in parts from an electrically conductive material. At least one of the contact elements can immerse into the material of the connecting element, thus forming a short circuit in the closed position. The connecting element can also immerse into the electrically conductive material of the contact elements, thereby forming a short circuit in the closed position. In the following, the terms penetrate and immerse can be understood synonymously. In the following, a porous material is described at various instances. The description apply accordingly also to pasty, liquid or powdery materials accordingly. A liquid metal can be mercury, for example.

According to an embodiment, it is proposed that due to the relative movement between at least one of the contact elements and the connecting element, at least one, preferably both contact elements, are immersed into the electrically conductive material of the connecting element or the connecting element is immersed into the electrically conductive material of at least one of the contact elements. Immersion can be understood as a mechanical penetration, in particular in the form of piercing or dipping in. By an appropriate design of the contact elements or the connecting element, an immersion into the electrically conductive material can be enhanced.

A connection is made between an immersing element and an element that is immersed. An immersing element can be at least one of the contact elements and the element that is immersed is in this case the connecting element. An immersing element can be the connecting element and the element is immersed is in this case at least one of the contact elements. The immersing element may be made at least in parts from the electrically conductive material.

In order to prevent loosening of the immersing element, it is proposed that the immersing element is formed with an undercut and/or hook-shaped and/or with a barb which is widened against the direction of immersion. The immersing element can be one of the contact elements immersing into the connecting element or the connecting element immersing into at least one of the contact elements.

In an end position, i.e. when the relative movement between the at least one contact element and the connecting element has ended, one or both contact elements may be circumferentially enclosed by the electrically conductive material of the connecting elements or the connecting element may be circumferentially enclosed by the electrically conductive material of at least one of the contact elements. In particular, an end region of the respective immersing element is preferably completely enclosed by the electrically conductive material. There is a mechanical and electrical connection between the immersing element and the electrically conductive material. Preferably, both contact elements immerse into the electrically conductive material of the connecting element. However, if there is already an electrical connection between one of the contact elements and the connecting element in the open position, only one of the contact elements can immerse the electrically conductive material.

In the opposite case, in which at least one, preferably both contact elements are formed of or have an electrically conductive material, it is proposed that the connecting element which has immersed into the electrically conductive material is circumferentially enclosed by the respective electrically conductive material of at least one of the contact elements. In particular, it is proposed that a respective end area of the connecting element is completely enclosed by the respective electrically conductive material.

Circumferentially enclosed can be understood to mean that along a circumference the immersing element is completely surrounded by the electrically conductive material and is circumferentially in contact with it. An end region can be an end face and a lateral surface of the immersing element facing away from the end face. The immersion depth can be between a few mm and several cm. The greater the immersion depth into the electrically conductive material, the greater the contact surface and thus the electrical conductivity or conductance between the connecting element and the contact element.

According to an embodiment, it is proposed that the electrically conductive material is a porous metal, in particular an open-pored or closed-pored metal foam, especially made of an aluminum material or a copper material. Whenever foam or metal foam is mentioned in the following, this can always be understood as the porous metal, whereby in this case the foam is only to be understood as an embodiment of the porous metal.

According to an embodiment, the porous metal has a mean pore diameter between 0.2 mm and 0.4 mm. The smaller the pore diameter, the denser the porous metal and the larger the contact area between the porous material and the element immersing it and the element being immersed.

As explained above, the contact element immerses into the connection element or vice versa. To facilitate immersion, the immersion element has a mandrel-shaped geometry, for example, conical. It is proposed that the tips of the contact elements are directed towards the connection element or the tips of the ends of the connection element are directed towards the respective contact element. The respective tips are preferably formed in the shape of a mandrel. The immersing element can also be formed in the shape of a cutting edge.

The tips are driven into the porous metal by an acceleration with the help of the drive, which creates an electrical and mechanical contact. Due to the porosity of the metal an immersion is possible, while at the same time a large holding force is realized.

According to an embodiment, it is proposed that the contact elements are formed integrally with the terminals. Thus, it is directly the terminals that are driven into the electrically conductive material.

According to an embodiment it is proposed that the connecting element is formed as a conductor bridge and that the relative movement causes the connecting element to be driven into the electrically conductive material of the contact elements. It should be noted that it may also be sufficient if only one end of a connecting element immerses into a contact element and the other end of the connecting element is already connected to the other contact element. This applies to all the embodiments.

According to an embodiment, it is proposed that the electrically conductive material is completely enclosed by a housing. However, it is also preferred that an insulating material is arranged on the surface of the electrically conductive material, into which at least one of the contact elements or the connecting element is immersed. This insulation prevents unwanted contact, for example by vibration. A sufficiently large force is required to immerse the insulation or the housing. This force is applied by the acceleration with the help of the drive. During immersion, accelerated by the drive, the connecting element or contact elements break through the housing wall.

The housing is preferably made of an insulating material, so that unintentional contacting is avoided.

According to an embodiment, it is proposed that the electrically conductive material completely encloses the connecting element and/or the contact elements after immersion, thus forming a force fit (non-positive connection) between the connecting element or the contact elements and the electrically conductive material.

The drive is electrical, electromechanical, magnetic, pyrotechnical or similar. An electromechanical drive can in particular be a spring drive, which can be triggered electrically. A magnetic drive can in particular be a relay drive. A pyrotechnical drive can be realized with the help of a pyrotechnical squib, which can be triggered by an electrical ignition impulse.

A porous metal can be manufactured in different ways, whereby in particular foaming of a propellant is used to manufacture the porous metal. Sintering of a metal powder can also lead to the porous material. The blowing agent is forced into a metal powder and the metal/blowing agent mixture is treated, in particular heated, whereby the blowing agent outgasses and foams and thus forms the porosity. It is also possible that in a casting process a metal-salt mixture is formed and then the salt is washed out and the remaining metal matrix forms the porous metal.

In the following, the subject matter will be explained in more detail by means of a drawing showing examples. In the drawing show:

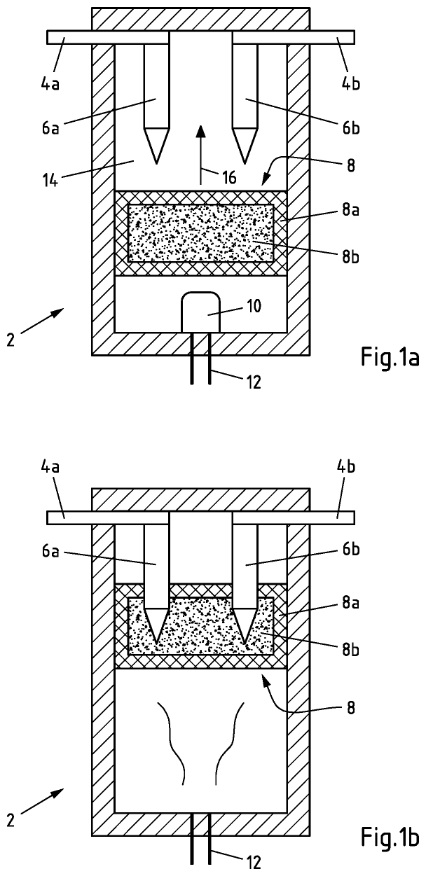

FIG. 1a a NO contact in an open position according to a first embodiment;

FIG. 1b a NO contact in a closed position as shown in FIG. 1a;

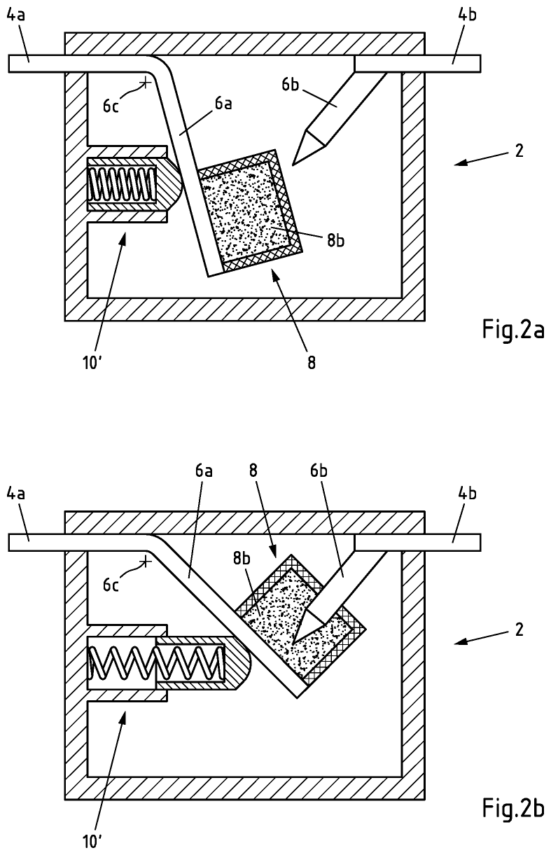

FIG. 2a a NO contact in an open position according to an embodiment;

FIG. 2b the NO contact as per FIG. 2a in a closed position;

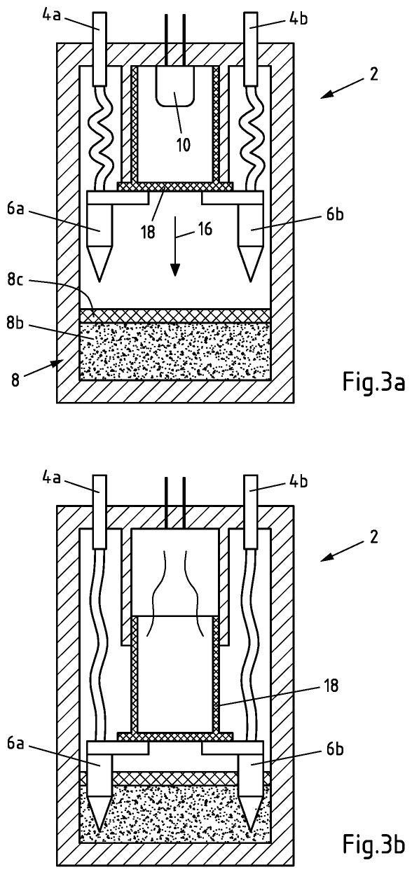

FIG. 3a a NO contact according to an example in an open position;

FIG. 3b the NO contact as shown in FIG. 3a in a closed position.

FIG. 1a shows a normally open contact 2 with a first terminal 4a and a second terminal 4b. The terminals 4a, b can be flat or round parts. The terminals 4a, b can be formed in particular as terminal lugs, terminal studs, crimp terminals, solder terminals, welding terminals or similar. The terminals 4a, b may be bimetallic or made of a metal. In particular, the terminals 4a, b may be made of a copper material or an aluminium material.

Contact elements 6a, 6b may be provided in one piece with which the terminals 4a, b or only electrically contacted with them. The contact elements 6a, b can be made of the same metal or a different metal as the terminals 4a, b. The contact elements 6a, 6b can be metallically coated. In particular, the contact elements 6a, b can be made of a copper material or an aluminium material.

The contact elements 6a, b can be formed in the shape of a mandrel on the front side and point in the direction of a connecting element 8.

A connecting element 8 can have a housing 8a and a metal foam 8b arranged in the housing 8a. The metal foam 8b is described in the following representative of a porous metal, so the following description is also applicable to any other porous metal.

The housing 8a is made of an insulating material, especially plastic, and preferably completely encases the metal foam 8b. On the side of the connecting element 8 facing away from the contact elements 6a, b , a drive 10 in the form of a squip can be provided. An electrical impulse can trigger the drive 10 via ignition wires 12, whereupon a gas pressure accelerates the connecting element in the direction of the contact elements 6a, b.

In the embodiment shown in FIG. 1a, the connecting element 8 is movably arranged in a channel 14 and can be moved in particular in the direction of movement 16 in channel 14. The movement of connecting element 8 in channel 14 in direction of movement 16 is triggered by drive 10.

In case of triggering, an ignition impulse is transmitted via the ignition wire 12 and the drive 10 ignites. Due to the gas pressure generated, connecting element 8 moves in direction of movement 16. The impulse of connecting element 8 is sufficiently large so that the contact elements 6a, b penetrate the housing 8a and immerse into the metal foam 8b. A mechanical and electrical connection is formed between the front faces of the contact elements 6a, b and the metal foam 8b. A short circuit is formed between the contact elements 6a, b via the metal foam 8b and the normally open contact 2 is in a closed position.

The connection element 8 remains in this closed position. Since the tips of the contact elements 6a, b are mechanically completely enclosed by the metal foam 8b, the connecting element 8 sticks to the contact elements 6a, b and a reset is prevented. Barbs or undercuts can also be arranged at the tips of the contact elements 6a, b (not shown) which prevent the connecting element 8 from moving against direction 16.

FIG. 2a shows another embodiment in which a contact element 6a is pivotally mounted about an axis 6c around the connecting element 4b. The contact element 6a is connected to the connecting element 8, in particular the metal foam 8b. In particular, the connecting element 8 including the metal foam 8b is captively arranged at the contact element 6a, for example by a material-locking joining of the metal foam 8b with a surface of the contact element 6a.

The drive 10′ is formed by a spring, which can be released electromagnetically, for example.

In case of triggering, the drive 10′ is triggered by an ignition impulse and the contact element 6a together with connecting element 8 is accelerated in the direction of the contact element 6b. Due to this relative movement, the contact element 6b immerses the metal foam 8b as shown in FIG. 2b and a short circuit is formed between the contact element 6a and the contact element 6b.

According to another embodiment, the contact elements 6a, 6b can also be accelerated in a direction of movement 16 in the direction of the connecting element 8, as shown in FIG. 3a, b. The contact elements 6a, b are connected to the connecting elements 4a, b in such a way that the contact elements 6a, b are movable in a direction of movement 16. A bolt 18 can be provided between the drive 10 and the contact elements 6a, b to ensure uniform acceleration of the contact elements 6a, b.

An insulation layer 8c can be provided between the front ends of the contact elements 6a, b and the connecting element 8. FIG. 3a shows an open position of the normally open contact 2. In the event of triggering, the drive 10 is triggered and the contact elements 6a, b are accelerated in the direction of movement 16 in the direction of the connecting element 8 via the bolt 18. The movement impulse is so large that the contact elements 6a, b penetrate the insulation layer 8c and immerse into the metal foam 8b. FIG. 3b shows the closed position in which a short circuit is formed between the contact elements 6a, b via the metal foam 8b.

### REFERENCE SIGNS

2 NO contact
4a, b Terminals
6a, b Contact elements
6c Axis
8 Connecting element
8a Housing
8b Metal foam
8c Insulation layer
10, 10′ Drive
12 Ignition wire
14 Channel
16 Direction of movement
18 Bolt

1-13. (canceled)

14. Electrical normally open contact (NO contact), in particular for a motor vehicle cable, in particular a motor vehicle power line, comprising:
a first electrical terminal;
a second electrical terminal,
a first contact element electrically connected to the first terminal;
a second contact element electrically connected to the second terminal;
a connecting element with which an electrical connection can be established between the two contact elements; and
a drive configured to cause a relative movement between at least one of the contact elements and the connecting element,
wherein the connecting element or the contact elements are formed at least in part from an electrically conductive, porous material wherein
the at least one contact element immersed into the electrically conductive material is circumferentially enclosed by the electrically conductive material of the connecting element or
the connecting element immersed into the electrically conductive material of at least one of the contact elements is circumferentially enclosed by the respective electrically conductive material of at least one of the contact elements.

15. Electrical normally open contact according to claim 14, wherein the relative movement of at least one of the contact elements causes the contact elements to immerses into the electrically conductive material of the connecting element, or the connecting element immerses into the porous material of at least one of the contact elements.

16. Electrical normally open contact according to claim 14, wherein
an end region of the at least one contact element is completely enclosed by the electrically conductive material, or
a respective end region of the connecting element is completely enclosed by the respective electrically conductive material.

17. Electrical normally open contact according to claim 14, wherein the electrically conductive material is a porous metal, in particular an open-pored or closed-pored metal foam, in particular made of an aluminium material or a copper material.

18. Electrical normally open contact according to claim 17, wherein the porous metal has an average pore diameter between 0.2 and 4 mm.

19. Electrical normally open contact according to claim 14, wherein at least one of the contact elements is formed in the shape of a mandrel and its tip is directed towards the connecting element, or in that the ends of the connecting element are formed in the shape of a mandrel and their tips are directed towards the respective contact element.

20. Electrical normally open contact according to claim 14, wherein at least one of the contact elements is formed integrally with at least one of the terminals.

21. Electrical normally open contact according to claim 14, wherein the connecting element is formed as a conductor bridge and in that the relative movement causes the connecting element to be immersed into the electrically conductive material of at least one of the contact elements.

22. Electrical normally open contact according to claim 14, wherein the electrically conductive material is completely enclosed by a housing and the connecting element and/or the contact elements break through the housing wall when immersed into the electrically conductive material.

23. Electrical normally open contact according to claim 22, wherein the housing is made of an insulating material.

24. Electrical normally open contact according to claim 14, wherein the electrically conductive material completely encloses the connecting element and/or the contact elements after immersion, thus forming a force fit connection between the connecting element or the contact elements and the electrically conductive material.

25. Electrical normally open contact according to claim 14, wherein the drive is electric, electromechanical, magnetic, pneumatic and/or pyrotechnical.

26. Electrical normally open contact according to claim 17, wherein the porous metal is formed by foaming a blowing agent in a metal-blowing agent mixture or by washing out a salt in a cast metal-salt mixture.
